(19) United States
(12) Patent Application Publication
(10) Pub. No.: US 2024/0146119 A1
(43) Pub. Date: May 2, 2024

(54) Adaptive Control Amplitude of ASK Communication

(71) Applicant: NuVolta Technologies (Hefei) Co., Ltd., Hefei (CN)

(72) Inventors: Ikgyoo Song, Suwon-si (KR); Jun Young Lee, Suwon-si (KR); Hwan Keol Yeo, Suwon-si (KR)

(21) Appl. No.: 18/157,263

(22) Filed: Jan. 20, 2023

(30) Foreign Application Priority Data
Oct. 28, 2022 (CN) 202211275293.5

(51) Int. Cl. H02J 50/05

(52) U.S. Cl. CPC H02J 50/05

(57) ABSTRACT

An apparatus for wireless power reception includes a receiver coil and a rectifier having a first input and a second input, the first input coupled to a first terminal of a receiver coil, the second input coupled to a second terminal of the receiver coil through a resonant capacitor. The apparatus further includes a first capacitor and a first switch network connected in series between the first input and ground and a second capacitor and a second switch network connected in series between the second input and ground, each of the first switch network and the second switch network including at least a plurality of field-effect transistors (FETs) connected in parallel, wherein the first switch network and the second switch network configured to adjust an impedance coupled to the receiver coil, the impedance associated with an Amplitude Shift Keying (ASK) modulation used by the apparatus.

### PRIORITY CLAIM

This application claims priority to Chinese Patent Application No. 202211275293.5, filed on Oct. 18, 2022, which is hereby incorporated by reference in its entirety.

### TECHNICAL FIELD

The present invention relates to a communication apparatus, and, in particular embodiments, to a communication apparatus in a receiver of a wireless power transfer system.

### BACKGROUND

As technologies further advance, wireless power transfer has emerged as an efficient and convenient mechanism for powering or charging battery based mobile devices such as mobile phones, tablet PCs, digital cameras, MP3 players and/or the like. A wireless power transfer system typically comprises a primary side transmitter and a secondary side receiver. The primary side transmitter is magnetically coupled to the secondary side receiver through a magnetic coupling. The magnetic coupling may be implemented as a loosely coupled transformer having a primary side coil formed in the primary side transmitter and a secondary side coil formed in the secondary side receiver.

The primary side transmitter may comprise a power conversion unit such as a primary side of a power converter. The power conversion unit is coupled to a power source and is capable of converting electrical power to wireless power signals. The secondary side receiver is able to receive the wireless power signals through the loosely coupled transformer and convert the received wireless power signals to electrical power suitable for a load.

In a wireless power transfer system, various control signals may be generated based upon the operating parameters at the secondary side receiver. The control signals may be transferred from the secondary side receiver to the primary side transmitter. In particular, the control signals may be transmitted from a receiver coil to a transmitter coil in the form of modulated signals using suitable modulation schemes. Amplitude shift keying (ASK) is a widely used modulation scheme in the receiver of the wireless power transfer system. ASK is carried out through modulating the amplitude of the analog signal in the wireless power transfer system. Information is passed through the amplitude variation of the analog signal. An analog sensing device is employed to detect the control signals, which may be included in the current and/or the voltage applied to the transmission coil. A demodulator at the primary side transmitter may be employed to demodulate the signals detected by the analog sensing device and feed the demodulated signals to a transmitter controller so as to better control the operation of the transmitter.

The communication information may be transferred from the receiver to the transmitter through varying the operating parameters of the transmitter. One relatively simple method to vary the operating parameters of the transmitter is based on an impedance modulation method. For example, a pair of capacitor-switch networks is coupled to two terminals of the receiver coil, respectively. The switches of the pair of capacitor-switch networks are switched on and off during communication so that the impedance coupled to the receiver coil is changed. The impedance variation has an impact on the electrical characteristics of the transmitter. In response to this impact, some operating parameters (e.g., the current flowing through the transmitter coil and/or the voltage across the transmitter coil) may vary. The control circuit in the transmitter detects the variation of at least one operating parameter and retrieves the communication information through demodulating the variation of this operating parameter.

Acoustic noise may occur in wireless charging transfer systems, especially for wireless chargers with a high charging capacity. One possible reason is that ceramic capacitors, which are popular in power electronics because they are thin and small, tend to expand when a voltage is applied to them and contract when the voltage is reduced. The voltage variation during the communication from the receiver to the transmitter may cause a deformation of a ceramic capacitor at a frequency range audible to humans. For instance, ceramic capacitors coupled to a rectifier of the receiver may generate acoustic noise due to variation of the voltage across the rectifier in the communication process. One solution to reduce the acoustic noise is to use acoustically quieter capacitors (e.g., Tantalum capacitors) as substitutes. The Tantalum capacitors are less easily to deform and thus may be quieter than the ceramic capacitors during the voltage variation. However, the Tantalum capacitors may not be as good as the ceramic capacitors for cost-sensitive and size-constrained applications such as the wireless power transfer system.

As the power of the wireless power transfer system goes higher, there may be a need for efficiently and quietly transferring communication information from the receiver to the transmitter, thereby controlling the operation of the transmitter in a reliable manner.

### SUMMARY

These and other problems are generally solved or circumvented, and technical advantages are generally achieved, by preferred embodiments of the present disclosure which provide a communication apparatus in a receiver of a wireless power transfer system.

In accordance with an embodiment, an apparatus for wireless power reception comprises a receiver coil and a rectifier having a first input and a second input, the first input coupled to a first terminal of the receiver coil, the second input coupled to a second terminal of the receiver coil through a resonant capacitor, the rectifier configured to convert an alternating current voltage into a direct current voltage for a load coupled to the apparatus. The apparatus further comprises a first capacitor and a first switch network connected in series between the first input and ground and a second capacitor and a second switch network connected in series between the second input and ground, each of the first switch network and the second switch network including at least a plurality of field-effect transistors (FETs) connected in parallel, wherein the first switch network and the second switch network configured to adjust an impedance coupled to the receiver coil, the impedance associated with an Amplitude Shift Keying (ASK) modulation used by the apparatus.

In accordance with an embodiment, a method comprises coupling a first capacitor and a first switch network connected in series between a first input of a rectifier and ground, the first input coupled to a first terminal of a receiver coil, the rectifier configured to convert an alternating current voltage into a direct current voltage for a load coupled to a receiver of a wireless power transfer system, the wireless power transfer system further including a transmitter, a transmitter coil of the transmitter magnetically coupled to the receiver coil. The method further comprises coupling a second capacitor and a second switch network connected in series between a second input of the rectifier and ground, the second input coupled to a second terminal of the receiver coil through a resonant capacitor, the first capacitor and the second capacitor located outside of a controller circuit. The method further comprises configuring, by the controller circuit, the first switch network and the second switch network to switch an impedance coupled to the receiver coil from a first impedance to a second impedance, the first impedance associated with a High state of an ASK modulation used by the receiver of the wireless power transfer system, the second impedance associated with a Low state of the ASK modulation. The method further comprises dynamically adjusting, by the controller circuit, configurations of the first switch network and the second switch network to change at least one of the first impedance and the second impedance.

In accordance with an embodiment, a controller circuit comprises a first switch network coupled between a first capacitor and ground, the first capacitor further coupled to a first terminal of a receiver coil and a second switch network coupled between a second capacitor and ground, the second capacitor further coupled to a second terminal of a receiver coil through a resonant capacitor, wherein the first terminal of the receiver coil and the second terminal of the receiver coil are coupled to a first input of a rectifier and a second input of the rectifier respectively, wherein the rectifier is configured to convert an alternating current voltage into a direct current voltage for a load coupled to the controller circuit, wherein the controller circuit is configured to control the first switch network and the second switch network to switch an impedance coupled to the receiver coil from a first impedance to a second impedance, the first impedance associated with a High state of an ASK modulation used by the wireless power reception system, the second impedance associated with a Low state of the ASK modulation, and wherein the controller circuit is further configured to dynamically adjust configurations of the first switch network and the second switch network to change at least one of the first impedance and the second impedance.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a block diagram of a wireless power transfer system in accordance with some embodiments;

FIG. 2 illustrates a block diagram of the receiver shown in FIG. 1 in accordance with some embodiments;

FIG. 3 illustrates a schematic diagram of the communication apparatus shown in FIG. 2 in accordance with some embodiments;

FIGS. 4A-D illustrate various embodiments of the capacitors and FETs in the controller circuit shown in FIG. 3;

FIGS. 5A-B illustrate block diagrams of the controller circuit configured to adjust the FET/switch networks based on local measurements in accordance with some embodiments; and

FIG. 6 illustrates a flow chart of applying an adaptive control mechanism to the controller circuit shown in FIG. 3 in accordance with some embodiments.

Corresponding numerals and symbols in the different figures generally refer to corresponding parts unless otherwise indicated. The figures are drawn to clearly illustrate the relevant aspects of the various embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present disclosure provides many applicable inventive concepts that can be embodied in a wide variety of specific contexts. The specific embodiments discussed are merely illustrative of specific ways to make and use the disclosure, and do not limit the scope of the disclosure.

The present disclosure will be described with respect to preferred embodiments in a specific context, namely a communication apparatus in a receiver of a wireless power transfer system. The disclosure may also be applied, however, to a variety of power systems. Hereinafter, various embodiments will be explained in detail with reference to the accompanying drawings.

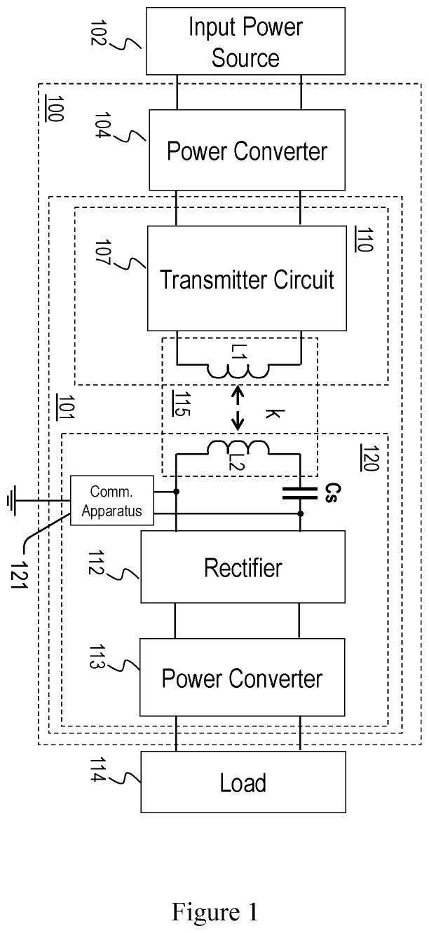

FIG. 1 illustrates a block diagram of a wireless power transfer system in accordance with various embodiments of the present disclosure. The wireless power transfer system 100 comprises a power converter 104 and a wireless power transfer device 101 connected in cascade between an input power source 102 and a load 114. In some embodiments, the power converter 104 is employed to further improve the performance of the wireless power transfer system 100. In alternative embodiments, the power converter 104 is an optional element. In other words, the wireless power transfer device 101 may be connected to the input power source 102 directly.

The wireless power transfer device 101 includes a power transmitter 110 and a power receiver 120 (which is also referred to as a receiver in the present disclosure). As shown in FIG. 1, the power transmitter 110 comprises a transmitter circuit 107 and a transmitter coil L1 connected in cascade. The input of the transmitter circuit 107 is coupled to an output of the power converter 104. The power receiver 120 comprises a receiver coil L2, a resonant capacitor Cs, a rectifier 112 and a power converter 113 connected in cascade. The power receiver 120 may further comprise a communication apparatus 121 connected between inputs of the rectifier 112 and ground. As shown in FIG. 1, the resonant capacitor Cs is connected in series with the receiver coil L2 and further connected to the inputs of the rectifier 112. The resonant capacitor Cs may help achieve soft switching for the wireless power transfer system. The outputs of the rectifier 112 are connected to the inputs of the power converter 113. The outputs of the power converter 113 are coupled to the load 114.

The power transmitter 110 is magnetically coupled to the power receiver 120 through a magnetic field when the power receiver 120 is placed near the power transmitter 110. A loosely coupled transformer 115 is formed by the transmitter coil L1, which is part of the power transmitter 110, and the receiver coil L2, which is part of the power receiver 120. As a result, electrical power may be transferred from the power transmitter 110 to the power receiver 120.

In some embodiments, the power transmitter 110 may be inside a charging pad. The transmitter coil L1 is placed underneath the top surface of the charging pad. The power receiver 120 may be embedded in a mobile phone. When the mobile phone is placed near the charging pad, a magnetic coupling may be established between the transmitter coil L1 and the receiver coil L2. In other words, the transmitter coil L1 and the receiver coil L2 may form a loosely coupled transformer through which a power transfer occurs between the power transmitter 110 and the power receiver 120. The strength of coupling between the transmitter coil L1 and the receiver coil L2 is quantified by the coupling coefficient k. In some embodiments, k is in a range from about 0.05 to about 0.9.

In some embodiments, after the magnetic coupling has been established between the transmitter coil L1 and the receiver coil L2, the power transmitter 110 and the power receiver 120 may form a power system through which power is wirelessly transferred from the input power source 102 to the load 114.

The input power source 102 may be a power adapter converting a utility line voltage to a direct-current (dc) voltage. Alternatively, the input power source 102 may be a renewable power source such as a solar panel array. Furthermore, the input power source 102 may be any suitable energy storage devices such as rechargeable batteries, fuel cells, any combinations thereof and/or the like.

The load 114 represents the power consumed by the mobile device (e.g., a mobile phone) coupled to the power receiver 120. Alternatively, the load 114 may refer to a rechargeable battery and/or batteries connected in series/parallel, and coupled to the output of the power receiver 120. Furthermore, the load 114 may be a downstream power converter such as a battery charger.

The transmitter circuit 107 may comprise primary side switches of a full-bridge converter according to some embodiments. Alternatively, the transmitter circuit 107 may comprise the primary side switches of any other suitable power converters such as a half-bridge converter, a push-pull converter, any combinations thereof and/or the like.

It should be noted that the power converters described above are merely examples. One having ordinary skill in the art will recognize other suitable power converters such as class E topology based power converters (e.g., a class E amplifier), may alternatively be used depending on design needs and different applications.

The transmitter circuit 107 may further comprise a resonant capacitor (not shown). The resonant capacitor and the magnetic inductance of the transmitter coil may form a resonant tank. Depending on design needs and different applications, the resonant tank may further include a resonant inductor. In some embodiments, the resonant inductor may be implemented as an external inductor. In alternative embodiments, the resonant inductor may be implemented as a connection wire.

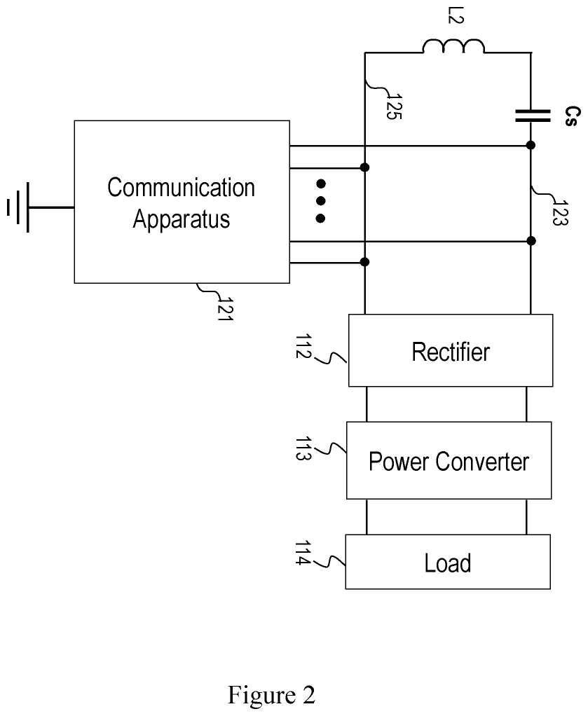

The power receiver 120 comprises the receiver coil L2 magnetically coupled to the transmitter coil L1 after the power receiver 120 is placed near the power transmitter 110. As a result, power may be transferred to the receiver coil and further delivered to the load 114 through the rectifier 112. The power receiver 120 may comprise a secondary resonant capacitor Cs as shown in FIG. 1. Throughout the description, the secondary resonant capacitor Cs may be alternatively referred to as a receiver resonant capacitor. The power receiver 120 may further comprise a communication apparatus (not shown but illustrated in FIG. 2).

The rectifier 112 converts an alternating polarity waveform received from the resonant tank comprising the receiver coil L2 and the receiver resonant capacitor Cs to a single polarity waveform. In some embodiments, the rectifier 112 comprises a full-wave diode bridge and an output capacitor. In alternative embodiments, the full-wave diode bridge may be replaced by a full-wave bridge formed by switching elements such as n-type metal oxide semiconductor (NMOS) transistors.

Furthermore, the rectifier 112 may be formed by other types of controllable devices such as metal oxide semiconductor field effect transistor (MOSFET) devices, bipolar junction transistor (BJT) devices, super junction transistor (SJT) devices, insulated gate bipolar transistor (IGBT) devices, gallium nitride (GaN) based power devices and/or the like. The detailed operation and structure of the rectifier 112 are well known in the art, and hence are not discussed herein.

The power converter 113 is coupled between the rectifier 112 and the load 114. The power converter 113 may be employed to further adjust the voltage/current applied to the load 114. The power converter 113 is a non-isolated power converter. In some embodiments, the power converter 113 is implemented as a step-down power converter such as a buck converter. In alternative embodiments, the power converter 113 is implemented as a four-switch buck-boost power converter.

Furthermore, the power converter 113 may be implemented as a hybrid power converter. The hybrid converter is a non-isolated power converter. By controlling the on/off of the switches of the hybrid converter, the hybrid converter can be configured as a buck converter, a charge pump converter or a hybrid converter.

Depending design needs and different applications, the hybrid converter may operate in different operating modes. More particularly, the hybrid converter may operate in a buck mode when the load current is less than a predetermined current threshold and/or the input voltage is less than a predetermined voltage threshold. In the buck mode, the hybrid converter is configured as a buck converter. The hybrid converter may operate in a charge pump mode or a hybrid mode when the input voltage is greater than the predetermined voltage threshold and/or the load current is greater than the predetermined current threshold. More particularly, in some embodiments, the hybrid converter may operate in a charge pump mode or a hybrid mode when a ratio of the output voltage of the hybrid converter to the input voltage of the hybrid converter is less than 0.5. In the charge pump mode, the hybrid converter is configured as a charge pump converter. In the hybrid mode, the hybrid converter is configured as a hybrid converter.

In some embodiments, the hybrid converter comprises a first switch, a capacitor and a second switch connected in series between the output of the rectifier 112 and the input of the load 114. The hybrid converter further comprises a third switch and a fourth switch. The third switch is connected between a common node of the first switch and the capacitor, and a common node of the second switch and the output terminal of the hybrid converter. The fourth switch is connected between a common node of the capacitor and the second switch, and ground.

Moreover, the power converter 113 may comprise a first power stage and a second power stage connected in cascade. The first power stage is configured to operate in different modes for efficiently charging the load 114 (e.g., a rechargeable battery). In some embodiments, the first stage may be implemented as a step-down power converter (e.g., a buck converter), a four-switch buck-boost converter, a hybrid converter and any combinations thereof. The second power stage is configured as a voltage divider or an isolation switch.

FIG. 2 illustrates a block diagram of the receiver shown in FIG. 1 in accordance with various embodiments of the present disclosure. As shown in FIG. 2, the receiver coil L2 and the receiver resonant capacitor Cs are connected in series. The receiver coil L2 is configured to be magnetically coupled to a transmitter coil (not shown). The receiver resonant capacitor Cs and the receiver coil L2 form a receiver resonant tank.

The two inputs of the rectifier 112 are connected to the receiver coil L2 and the receiver resonant capacitor Cs respectively. More particularly, a first input of the rectifier 112 is connected to the receiver resonant capacitor Cs through a first bus 123. A second input of the rectifier 112 is connected to the receiver coil L2 through a second bus 125. The outputs of the rectifier 112 are connected to the inputs of the power converter 113. The outputs of the power converter 113 are connected to the load 114.

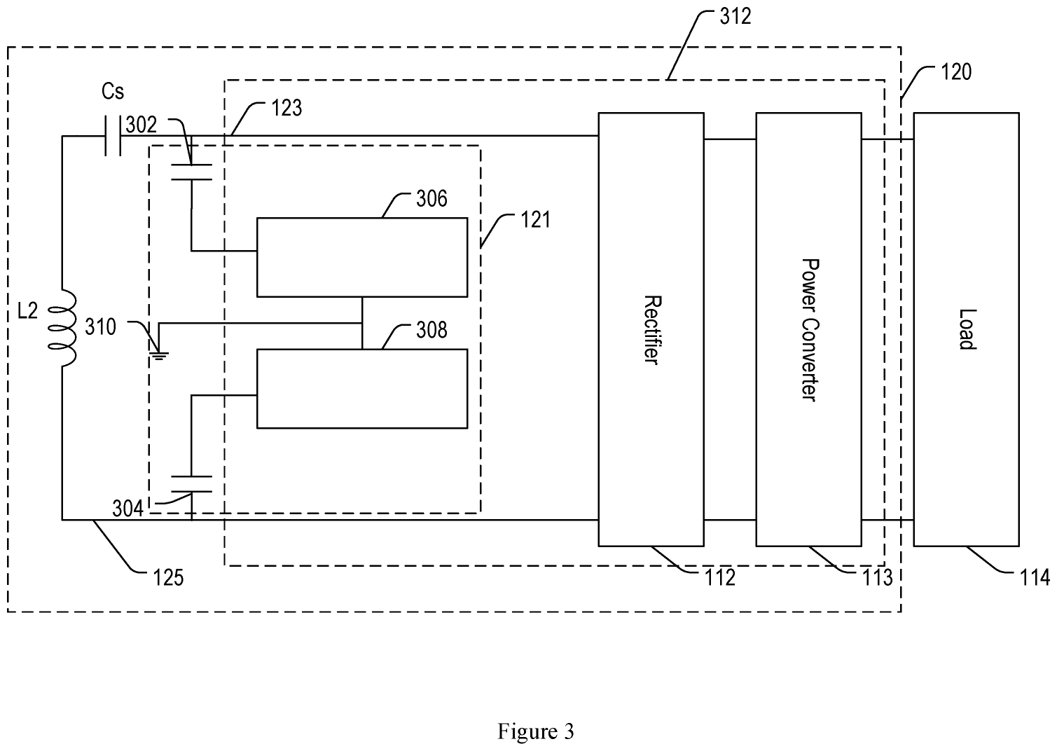

As shown in FIG. 2, a communication apparatus 121 is connected between the inputs of the rectifier 112 and ground. More particularly, the communication apparatus 121 may have one or more first terminals connected to the first bus 123, and one or more second terminals connected to the second bus 125. The detailed schematic diagram of the communication apparatus 121 will be described below with respect to FIG. 3.

In some embodiments, the communication apparatus 121 comprises one or more capacitor-switch networks. Each of the one or more capacitor-switch networks may be controlled independently. In operation, the receiver is configured to send one or more control signals (communication information) to the transmitter magnetically coupled to the receiver. The one or more control signals are transmitted through suitable modulation schemes such as amplitude shift keying (ASK). The ASK modulation scheme may be implemented by adjusting the impedance coupled to the receiver coil L2. As a result of adjusting the impedance coupled to the receiver coil L2, the gain of the wireless power transfer system varies accordingly. The controller on the transmitter side detects the variation of the gain through analyzing the current flowing through the transmitter coil and/or the voltage across the transmitter coil. The variation of the gain can be demodulated to retrieve the control signals sent from the receiver.

In a conventional communication apparatus, a pair of capacitor-switch networks is coupled to a first terminal and a second terminal of the receiver coil respectively. The two switches of the pair of capacitor-switch networks are controlled by a same control signal. In other words, these two switches are not controlled independently. The two switches of the pair of capacitor-switch networks are turned on and off simultaneously. With such a control mechanism, a pair of capacitor-switch networks can only generate two different impedance variations. In particular, when both switches are turned off, a first impedance arrangement is applied to the receiver coil. On the other hand, when both switches are turned on, a second impedance arrangement is applied to the receiver coil. In order to have more impedance variations, the conventional communication apparatus requires more capacitor-switch networks, which may increase the bills of material (BOM) cost and amount of passive components. In addition, in the conventional communication apparatus, the association between the impedance variations and the ASK modulation cannot be dynamically adjusted during the communication process.

In the present disclosure, the communication apparatus 121 may be configured to generate a plurality of impedance variations more efficiently and more flexibly. The communication apparatus 121 may select two different impedances from the plurality of impedance variations it is configured to generate and switch between these two impedances during the ASK modulation based communication. A half waveform of the voltage between outputs of the rectifier 112 may be referred to as Vrect. The amplitude of the Vrect is affected by an impedance coupled between the first input and the second input of the rectifier 112. Thus, one of the selected two impedances leads to a lower level amplitude of the Vrect, and another leads to a higher level amplitude of the Vrect. In other words, the lower level amplitude of the Vrect is associated with a Low state of the ASK modulation, and the higher level amplitude of the Vrect is associated with a High state of the ASK modulation.

As discussed above, capacitors coupled to the rectifier 112 may generate acoustic noise due to a gap between the higher level amplitude and the lower level amplitude of the Vrect. Decreasing the gap may reduce the acoustic noise. When the communication apparatus 121 is capable of generating more impedance variations, it is allowed to select a pair of impedances associated with the Low state and the High state of the ASK modulation respectively that result in a smaller gap, which may make the wireless power transfer system quieter. Furthermore, aspects of the present disclosure provide embodiment techniques that dynamically adjust the selected impedances for the Low state and the High state of the ASK modulation during the communication between the transmitter and the receiver of the wireless power transfer system. The detailed structure and operating principle of the communication apparatus 121 will be discussed below.

FIG. 3 illustrates a schematic diagram of the communication apparatus of the receiver shown in FIG. 2 in accordance with various embodiments of the present disclosure. The receiver 120 comprises the receiver coil L2, the receiver resonant capacitor Cs, the communication apparatus 121, the rectifier 112, and the power converter 113. As shown in FIG. 3, the receiver resonant capacitor Cs, the rectifier 112 and the power converter 113 are connected in cascade between the receiver coil L2 and the load 114. The communication apparatus 121 is coupled to the bus 123 and the bus 125.

The communication apparatus 121 comprises a capacitor 302 and a field-effect transistor (FET) network 306 connected in series between the bus 123 and ground. In the present disclosure, a FET network may also be referred to as a switch network. The communication apparatus 121 further comprises a capacitor 304 and a FET network 308 connected in series between the bus 125 and ground. In various embodiments, the communication apparatus 121 may include more capacitors and more FET networks. Each of the FET network 306 and the FET network 308 includes at least one FET. The FET networks 306 and 308 are controlled by the communication apparatus 121 to change the impedance coupled to the receiver coil L2 so as to vary the operating parameters in the transmitter (e.g., the current flowing through the transmitter coil and/or the voltage across the transmitter coil).

In various embodiments, the FET/switch network 306, the FET/switch network 308, the rectifier 112 and the power converter 113 may be integrated in one single chip 312. Alternatively, only the FET/switch network 306 and the FET/switch network 308 are integrated in one single chip 312. The chip 312 may also be referred to as a controller circuit of the wireless power transfer system.

In some embodiments, the gate drive voltages of the FETs in the communication apparatus 121 may be adjusted so that each FET may function as a switch, or a resistor, or both. In various embodiments, depending on the gate drive voltage, a FET in the communication apparatus 121 may operate in one of at least three modes: saturation mode where the FET functions as a switch that is turned on with a small on resistance, cut-off mode where the FET functions as a switch that is turned off, and ohmic mode where the FET functions as a resistor whose resistance is controlled by the gate drive voltage. As such, the communication apparatus 121 includes a capacitor-resistor network. The capacitor-resistor network comprises one or more control variable, namely the resistance of the FETs. The resistance of each FET may be adjustable through adjusting the corresponding gate drive voltage. As a result, the capacitor-resistor network becomes an adjustable impedance network coupled to the receiver coil. The communication apparatus 121 is able to generate a plurality of impedance variations by adjusting the capacitor-resistor network. During the communication process, the communication apparatus 121 may select two suitable impedances from the plurality of impedance variations and associate the selected impedances with the Low state and the High state of the ASK modulation.

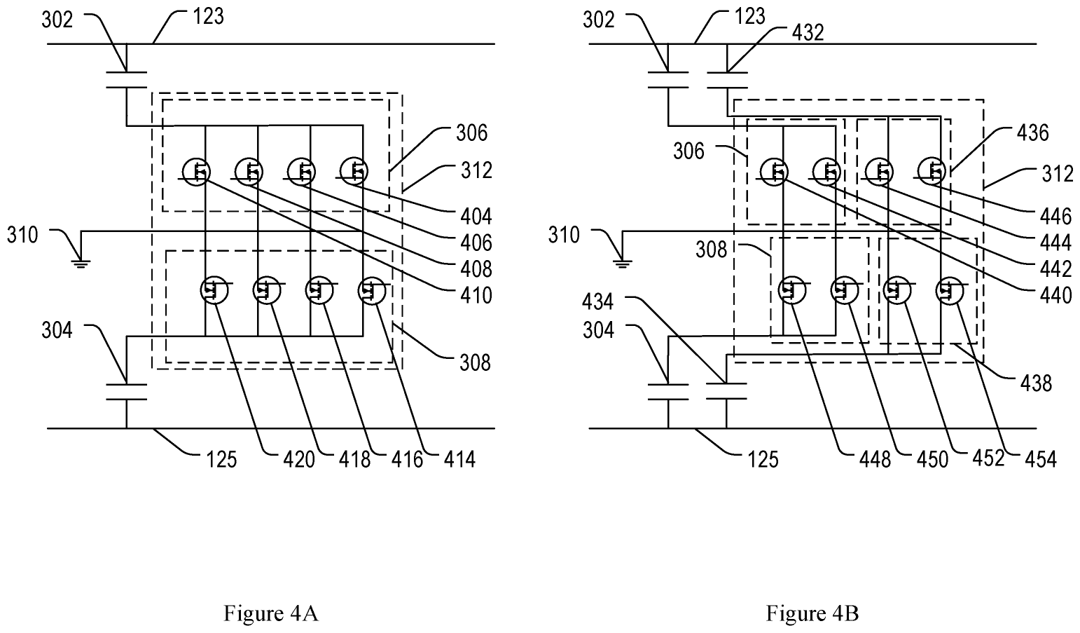

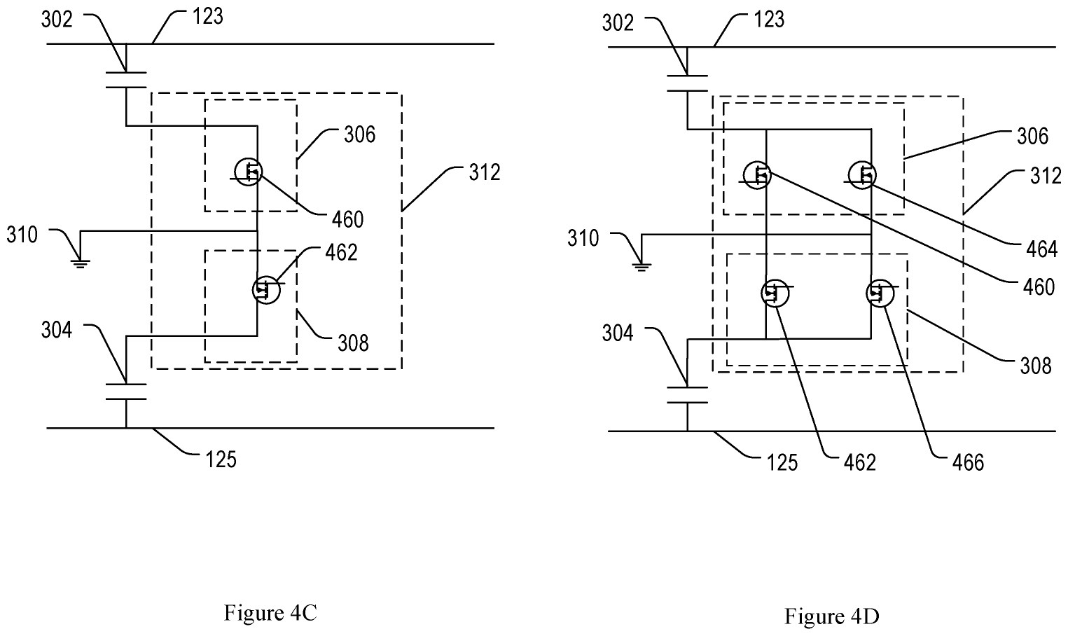

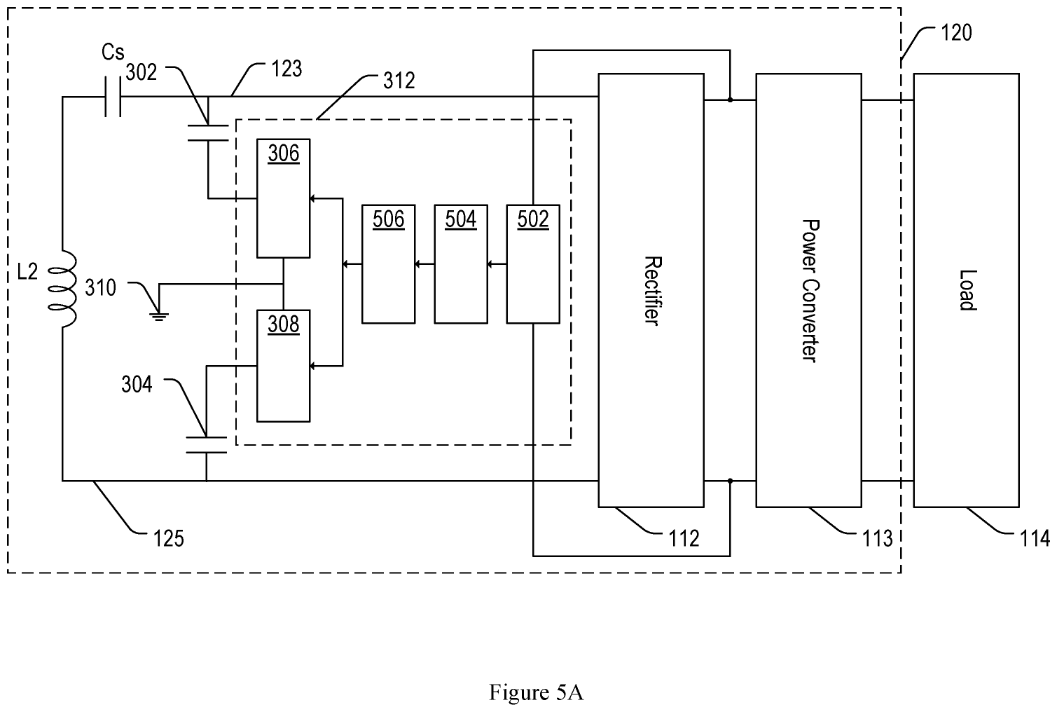

FIGS. 4A-4D illustrate various embodiments of the capacitors and FETs in the receiver 120. In one embodiment depicted in FIG. 4A, the receiver 120 comprises the capacitor 302 and the FET network 306 connected in series between the bus 123 and ground. The receiver 120 further comprises the capacitor 304 and the FET network 308 connected in series between the bus 125 and ground. The FET network 306 includes four FETs 404, 406, 408, and 410 connected in parallel. The FET network 308 includes four FETs 414, 416, 418, and 420 connected in parallel. A plurality of impedance variations may be generated by switching on or off one or more of the FETs in the FET networks 306 and 308. A first impedance may be generated when all of the FETs 404, 406, 408, 410, 414, 416, 418, and 420 are switched on. A second impedance may be generated when the FETs 404 and 414 are switched off and the FETs 406, 408, 410, 416, 418, and 420 are switched on. A third impedance may be generated when the FETs 404, 406, 414, and 416 are switched off and the FETs 408, 410, 418, and 420 are switched on. A fourth impedance may be generated when the FETs 404, 406, 408, 414, 416, and 418 are switched off and the FETs 410 and 420 are switched on. A fifth impedance may be generated when the FETs 404, 408, 414, and 418 are switched off and the FETs 406, 410, 416, and 420 are switched on. Similarly, some other different impedances may be generated when different FETs in the FET networks 306 and 308 are switched off and the other FETs in the FET networks 306 and 308 are switched on.

FIG. 4B illustrates another embodiment, where the receiver 120 comprises more capacitors and corresponding FET networks. Specifically, in this embodiment, the receiver 120 includes the capacitor 302 and the FET network 306 connected in series between the bus 123 and ground, the capacitor 304 and the FET network 308 connected in series between the bus 125 and ground, a capacitor 432 and a FET network 436 connected in series between the bus 123 and ground, and a capacitor 434 and a FET network 438 connected in series between the bus 125 and ground. The FET network 306 includes two FETs 440 and 442 connected in parallel. The FET network 308 includes two FETs 448 and 450 connected in parallel. The FET network 436 includes two FETs 444 and 446 connected in parallel. The FET network 438 includes two FETs 452 and 454 connected in parallel. A plurality of impedance variations may be generated by switching on or off one or more of the FETs in the FET networks 306, 308, 436, and 438. A first impedance may be generated when all of the FETs 440, 442, 444, 446, 448, 450, 452, and 454 are switched on. A second impedance may be generated when the FETs 440 and 448 are switched off and the FETs 442, 444, 446, 450, 452, and 454 are switched on. A third impedance may be generated when the FETs 440, 442, 448, and 450 are switched off and the FETs 444, 446, 452, and 454 are switched on. A fourth impedance may be generated when the FETs 440, 442, 444, 448, 450, and 452 are switched off and the FETs 446 and 454 are switched on. A fifth impedance may be generated when the FETs 440, 448, 444, and 452 are switched off and the FETs 442, 450, 446, and 454 are switched on. Similarly, some other different impedances may be generated when different FETs in the FET networks 306, 308, 436, and 438 are switched off and the other FETs in the FET networks 306, 308, 436, and 438 are switched on.

In another embodiment depicted in FIG. 4C, the receiver 120 comprises the capacitor 302 and the FET network 306 connected in series between the bus 123 and ground. The receiver 120 further comprises the capacitor 304 and the FET network 308 connected in series between the bus 125 and ground. The FET network 306 includes a FET 460. The FET network 308 includes a FET 462. Both the FETs 460 and 462 may operate in ohmic mode. In other words, the on resistance of each of the FET 460 and the FET 462 is controlled by the gate drive voltage of the corresponding FET. Thus, a plurality of impedance variations may be generated by providing various gate drive voltages to the FET 460 and the FET 462, respectively.

In yet another embodiment illustrated in FIG. 4D, the receiver 120 comprises the capacitor 302 and the FET network 306 connected in series between the bus 123 and ground. The receiver 120 further comprises the capacitor 304 and the FET network 308 connected in series between the bus 125 and ground. The FET network 306 includes a FET 460 and a FET 464. The FET network 308 includes a FET 462 and a FET 466. Each of the FETs 460, 462, 464, and 466 may function as a switch, or a resistor, or both depending on its gate drive voltage. In one example, the FET 460 and the FET 462 may function as switches, and the FET 464 and the FET 466 may operate in ohmic mode. Thus, a plurality of impedance variations may be generated by turning on or off one or more of the FETs 460 and 462 and providing various gate drive voltages to the FET 464 and the FET 466, respectively. In another example, the FETs 460, 462, 464, and 466 may all operate in ohmic mode. A plurality of impedance variations may be generated by providing various configurations of gate drive voltages to these FETs.

The specific embodiments depicted in FIGS. 4A-4D are merely illustrative, and thus should not be construed in a limited scope. Any suitable number of capacitors and FETs may be used in the receiver 120. Furthermore, persons skilled in the art may implement specific devices that utilize any of the embodiments shown in FIGS. 4A-4D, or combine all or only a subset of these embodiments in one single device.

The receiver 120 may include the controller circuit 312. In various embodiments, the one or more FET/switch networks in the receiver 120 may be located inside the controller circuit 312. The FETs in the one or more FET/switch networks in the receiver 120 may be controlled by control signals provided by the controller circuit 312. In one embodiment, the control signals provided by the controller circuit 312 may be signals that affect the gate drive voltages of the FETs in the receiver 120. In another embodiment, the control signals may include the gate drive voltages of the FETs in the receiver 120. In some embodiments, the controller circuit 312 may include the rectifier 112 and the power converter 113 (which are not shown in FIGS. 4A-4D). Alternatively, in various embodiments, the rectifier 112 and the power converter 113 are located outside the controller circuit 312.

The receiver 120 may select two different impedances from the plurality of impedance variances generated by different configurations of the FETs in the receiver 120. The receiver 120 may associate these two different impedances with the Low state and the High state of the ASK modulation. For example, using the FET networks shown in FIG. 4A, during the High state of the ASK modulation, the receiver 120 may turn on the FETs 404, 406, 408, 410, 414, 416, 418, and 420 to couple the first impedance to the receiver coil L2. During the Low state of the ASK modulation, the receiver 120 may turn off FETs 404, 406, 408, 414, 416, and 418 and turn on the FETs 410 and 420 to couple the fourth impedance to the receiver coil L2. If such configuration does not satisfy requirements of the receiver 120 or the wireless power transfer system, the receiver 120 may select a different pair of impedances and associate the newly selected impedances with the Low state and the High state of the ASK modulation. For example, a ceramic capacitor coupled to the rectifier 112 may generate too much noise due to the large gap between the higher level amplitude and the lower level amplitude of the Vrect. The receiver 120 may still use the first impedance during the High state of the ASK modulation. But during the Low state of the ASK modulation, the receiver 120 may couple the third impedance to the rectifier 112 instead. In other words, during the Low state of the ASK modulation, the receiver 120 may switch off the FETs 404, 406, 414, and 416 and switch on the FETs 408, 410, 418, and 420. The noise issue may be solved because the gap between the higher level amplitude and the lower level amplitude of the Vrect is reduced by the newly selected impedances.

In some embodiments, the selection of impedances for the ASK modulation may be pre-determined and changed semi-statically. For example, the selection may be determined each time before the receiver 120 is powered on. In other embodiments, the selection of impedances for the ASK modulation may be adjusted dynamically during the communication process, which also is referred to as adaptive control of the ASK modulation in the present disclosure. The adaptive control of the ASK modulation may be based on various criteria. Factors that may determine the selection of impedances for the ASK modulation include the acoustic noise, the quality of the communication channel between the transmitter and the receiver, and the power loss during the wireless power transfer.

For example, the selection of impedances for the ASK modulation may be dynamically adjusted to improve the quality of the communication between the transmitter and the receiver. Specifically, the transmitter retrieves the data transmitted from the receiver by detecting the variation of the current flowing through the transmitter coil and/or the voltage across the transmitter coil. A larger variation may make it easier for the transmitter to demodulate the received data. Thus, if the transmitter finds the current communication channel between the transmitter and the receiver is unreliable or not satisfactory, the transmitter may provide feedback to the receiver. Then upon receiving the feedback, the receiver may select a new pair of impedances for the ASK modulation that provide a larger variation of the current flowing through the transmitter coil and/or the voltage across the transmitter coil.

In another example, the selection of impedances for the ASK modulation may be dynamically adjusted to reduce power loss during charge pump application. Power loss may be caused by the lower level amplitude of the Vrect. Thus, the receiver may select a pair of impedances for the ASK modulation that increase the lower level amplitude of the Vrect to reduce the power loss during the wireless power transfer.

In various embodiments, the adaptive control of the ASK modulation may be based on any of the above factors or a trade-off of any combination of the above factors. Any other suitable factors may also be considered for the adaptive control of the ASK modulation.

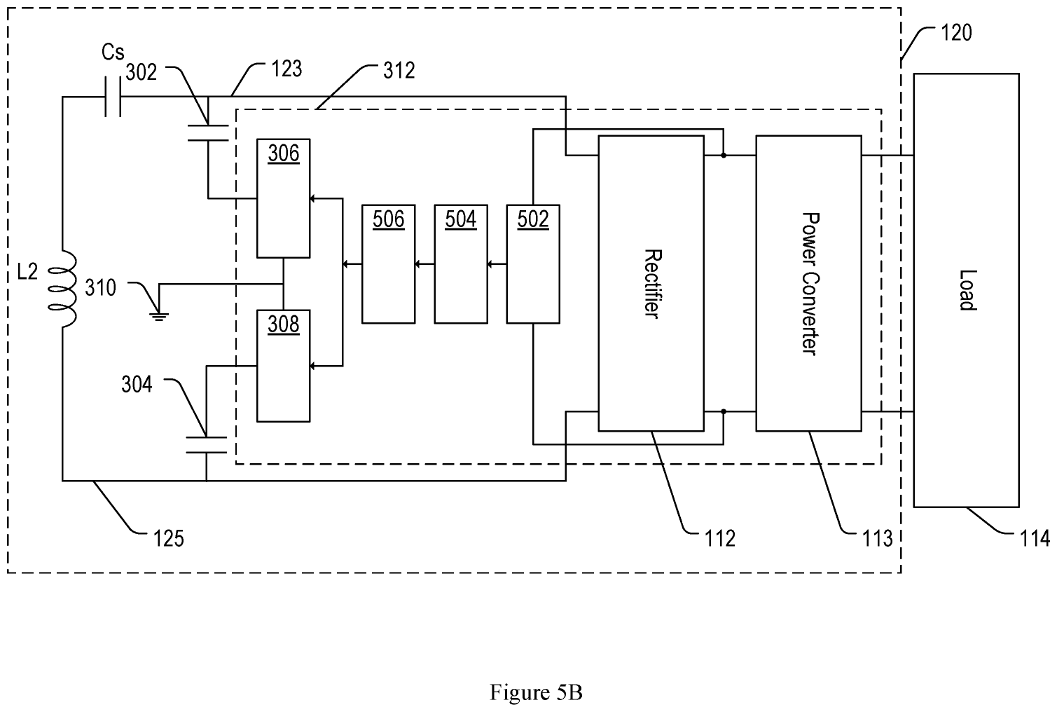

In some embodiments, the adaptive control of the ASK modulation may be triggered by local measurements performed in the receiver. The receiver or a controller circuit located in the receiver may perform the adaptive control the ASK modulation in accordance with various local signals measured at the receiver. The receiver or the controller circuit located in the receiver may perform the adaptive control the ASK modulation without relying on any feedback from the transmitter. FIGS. 5A-B illustrate block diagrams of a controller circuit configured to adjust the FET networks based on local measurements in accordance with various embodiments of the present disclosure. As shown in FIG. 5A, the receiver 120 includes the capacitors 302 and 304 and the controller circuit 312. The controller circuit 312 includes the FET network 306 coupled between the capacitor 302 and ground and the FET network 308 coupled between the capacitor 304 and ground. The controller circuit 312 further includes a measurement circuit 502 coupled to outputs of the rectifier 112, a detection circuit 504, and a driver circuit 506. The measurement circuit 502 may include at least an analog-to-digital converter (ADC) and is configured to measure an output voltage of the rectifier 112 (Vrect). The detection circuit 504 may be configured to determine the difference between the lower level amplitude and the higher level amplitude of the Vrect and output the determined difference to the driver circuit 506. The driver circuit 506 is configured to generate control signals for the FET networks 306 and 308 based on outputs of the detection circuit 504. In the example illustrated by FIG. 5A, the rectifier 112 and the power converter 113 are located outside of the controller circuit 312.

In another embodiment illustrated by FIG. 5B, the controller circuit 312 may include the rectifier 112 and the power converter 113. As shown in FIG. 5B, the controller circuit 312 may further include the FET network 306 and the FET network 308. The controller circuit 312 further includes the measurement circuit 502 coupled to the outputs of the rectifier 112, the detection circuit 504, and the driver circuit 506. The measurement circuit 502, the detection circuit 504, and the driver circuit 506 may function similarly to those described with regards to FIG. 5A.

In various embodiments, the adaptive control of the ASK modulation may be triggered by feedback from the transmitter. The receiver or a controller circuit located in the receiver may perform the adaptive control the ASK modulation in accordance with various feedback transmitted from the transmitter. The receiver or the controller circuit located in the receiver may perform the adaptive control the ASK modulation relying on merely the feedback from the transmitter or both the feedback from the transmitter and the measurement performed at the receiver. In one example, the feedback from the transmitter may include instructions on how to adjust the ASK modulation. The transmitter may determine a specific adjustment to the ASK modulation based on local measurement preformed at the receiver and transmit the adjustment decision to the receiver through a feedback channel. Upon receiving the feedback, the receiver may change the ASK modulation as instructed. In another example, the feedback from the transmitter may include local measurement preformed at the transmitter. The transmitter may merely send its local measurement results to the receiver through the feedback channel. Upon receiving the feedback, the receiver may determine how to adjust the ASK modulation based on the measurement results at the transmitter. In various embodiments, the receiver may determine how to adjust the ASK modulation based on both the measurement performed at the transmitter and the measurement performed at the receiver.

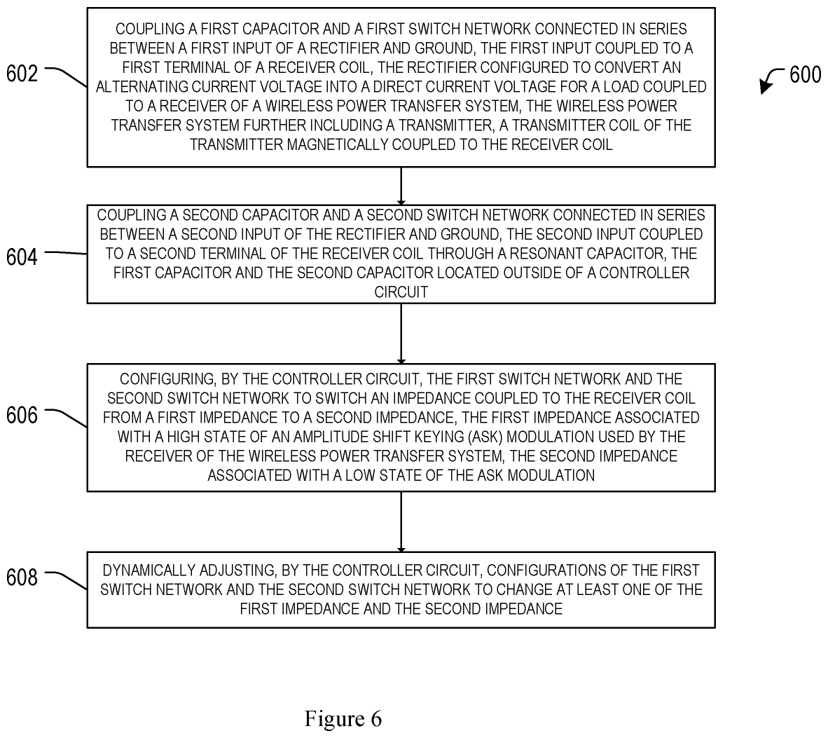

FIG. 6 illustrates a flow chart of applying an adaptive control mechanism to the controller circuit shown in FIGS. 3, 4, and 5A-B in accordance with various embodiments of the present disclosure. This flowchart is merely an example, which should not unduly limit the scope of the claims. One of ordinary skill in the art would recognize many variations, alternatives, and modifications. For example, various steps illustrated in FIG. 6 may be added, removed, replaced, rearranged and repeated.

A wireless power transfer system (e.g., wireless power transfer system shown in FIG. 1) comprises a transmitter and a receiver. The transmitter comprises a full bridge, a transmitter resonant capacitor and a transmitter coil. The receiver comprises a receiver coil, a receiver resonant capacitor and a rectifier. The transmitter coil is magnetically coupled to the receiver coil. The wireless power transfer system may further comprise a communication apparatus placed in the receiver. The receiver includes a controller circuit (such as the controller circuit 312 shown in FIGS. 3, 4, and 5A-B).

At step 602, a first capacitor and a first switch network connected in series are configured to be coupled between a first input of a rectifier and ground. The first input may be coupled to a first terminal of a receiver coil. The rectifier is configured to convert an alternating current voltage into a direct current voltage for a load coupled to the receiver of the wireless power transfer system.

At step 604, a second capacitor and a second switch network connected in series are configured to be coupled between a second input of the rectifier and ground. The second input may be coupled to a second terminal of the receiver coil through a resonant capacitor. The first capacitor and the second capacitor may be located outside of the controller circuit.

At step 606, the controller circuit configures the first switch network and the second switch network to switch an impedance coupled to the receiver coil from a first impedance to a second impedance. The first impedance may be associated with a High state of an ASK modulation used by the receiver of the wireless power transfer system, and the second impedance may be associated with a Low state of the ASK modulation.

At step 608, the controller circuit dynamically adjusts configurations of the first switch network and the second switch network to change at least one of the first impedance and the second impedance.

Although embodiments of the present disclosure and its advantages have been described in detail, it should be understood that various changes, substitutions and alterations can be made herein without departing from the spirit and scope of the disclosure as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. An apparatus for wireless power reception comprising:
a receiver coil;
a rectifier having a first input and a second input, the first input coupled to a first terminal of the receiver coil, the second input coupled to a second terminal of the receiver coil through a resonant capacitor, the rectifier configured to convert an alternating current voltage into a direct current voltage for a load coupled to the apparatus;
a first capacitor and a first switch network directly connected in series between the first input and ground, wherein the first switch network comprises at least two field-effect transistors (FETs) connected in parallel; and
a second capacitor and a second switch network directly connected in series between the second input and ground, wherein the second switch network comprises including at least two FETs connected in parallel, and wherein the first switch network and the second switch network are configured to adjust an impedance coupled to the receiver coil, the impedance comprising a first impedance and a second impedance, the first impedance associated with a High state of an Amplitude Shift Keying (ASK) modulation used by the apparatus, and the second impedance associated with a Low state of the ASK modulation, and wherein a first FET and a second FET of the first switch network are connected in parallel, the first FET is controlled by an ON/OFF control mechanism, and the second FET is controlled by an adjustable gate drive voltage control mechanism.

2-3. (canceled)

4. The apparatus of claim 1, wherein:
the first switch network includes the first FET and the second FET operating in an ohmic mode;
the second switch network includes a third FET and a fourth FET operating in the ohmic mode;
the first impedance is coupled to the receiver coil when the first FET, the second FET, the third FET, and the fourth FET are controlled by a first configuration of gate drive voltages; and
the second impedance is coupled to the receiver coil when the first FET, the second FET, the third FET, and the fourth FET are controlled by a second configuration of gate drive voltages.

5. The apparatus of claim 1, wherein:
the first switch network includes the first FET and the second FET, the second FET operating in an ohmic mode;
the second switch network includes a third FET and a fourth FET, the fourth FET operating in the ohmic mode;
the first impedance is coupled to the receiver coil when the first FET and the third FET are turned on, and the second FET and the fourth FET are controlled by a first configuration of gate drive voltages; and
the second impedance is coupled to the receiver coil when the first FET and the third FET are turned on, and the second FET and the fourth FET are controlled by a second configuration of gate drive voltages.

6. The apparatus of claim 1, wherein the apparatus is included in a wireless power transfer system, and wherein the wireless power transfer system further includes a transmitter, a transmitter coil of the transmitter magnetically coupled to the receiver coil.

7. The apparatus of claim 6, wherein the impedance is adjusted in accordance with measurements of a voltage between a first output and a second output of the rectifier.

8. The apparatus of claim 6, wherein the impedance is adjusted in accordance with feedback from the transmitter.

9. A method comprising:
coupling a first capacitor and a first switch network directly connected in series between a first input of a rectifier and ground, the first input coupled to a first terminal of a receiver coil, the rectifier configured to convert an alternating current voltage into a direct current voltage for a load coupled to a receiver of a wireless power transfer system, the wireless power transfer system further including a transmitter, a transmitter coil of the transmitter magnetically coupled to the receiver coil, wherein the first switch network comprises at least two FETs connected in parallel;
configuring a first FET of the first switch network to function as a switch, and configuring a second FET of the first switch network to operate in an ohmic mode at the same time, wherein the first FET and the second FET are connected in parallel;
coupling a second capacitor and a second switch network directly connected in series between a second input of the rectifier and ground, the second input coupled to a second terminal of the receiver coil through a resonant capacitor, the first capacitor and the second capacitor located outside of a controller circuit, wherein the second switch network comprises at least two FETs connected in parallel;
configuring, by the controller circuit, the first switch network and the second switch network to switch an impedance coupled to the receiver coil from a first impedance to a second impedance, the first impedance associated with a High state of an Amplitude Shift Keying (ASK) modulation used by the receiver of the wireless power transfer system, the second impedance associated with a Low state of the ASK modulation; and
dynamically adjusting, by the controller circuit, configurations of the first switch network and the second switch network to change at least one of the first impedance and the second impedance.

10-13. (canceled)

14. The method of claim 9, wherein the first switch network includes the first FET and the second FET operating in the ohmic mode and the second switch network includes a third FET and a fourth FET operating in the ohmic mode;
providing a first configuration of gate drive voltages to the first FET, the second FET, the third FET, and the fourth FET to couple the first impedance to the receiver coil; and
providing a second configuration of gate drive voltages to the first FET, the second FET, the third FET, and the fourth FET to couple the second impedance to the receiver coil.

15. The method of claim 9, wherein the first switch network includes the first FET and the second FET and the second switch network includes a third FET and a fourth FET; and
turning on the first FET and the third FET and operating the second FET and the fourth FET both in the ohmic mode controlled by a configuration of gate drive voltages to couple the second impedance to the receiver coil.

16. The method of claim 9, wherein the configurations of the first switch network and the second switch network are dynamically adjusted to change at least one of the first impedance and the second impedance in accordance with measurements of an output voltage of the rectifier, or feedback from the transmitter, or both.

17. A wireless power reception system comprising:
a first switch network directly coupled between a first capacitor and ground, the first capacitor further coupled to a first terminal of a receiver coil, wherein the first switch network comprises at least two FETs connected in parallel; and
a second switch network directly coupled between a second capacitor and ground, the second capacitor further coupled to a second terminal of a receiver coil through a resonant capacitor, wherein the second switch network comprises at least two FETs connected in parallel, and wherein:
the first terminal of the receiver coil and the second terminal of the receiver coil are coupled to a first input of a rectifier and a second input of the rectifier respectively;
the rectifier is configured to convert an alternating current voltage into a direct current voltage for a load coupled to the wireless power reception system;
a controller circuit is configured to control the first switch network and the second switch network to switch an impedance coupled to the receiver coil from a first impedance to a second impedance, the first impedance associated with a High state of an Amplitude Shift Keying (ASK) modulation used by the wireless power reception system, the second impedance associated with a Low state of the ASK modulation; and
the controller circuit is further configured to dynamically adjust configurations of the first switch network and the second switch network to change at least one of the first impedance and the second impedance, and wherein a first FET and a second FET of the first switch network are connected in parallel, the first FET is controlled by an ON/OFF control mechanism, and the second FET is controlled by an adjustable gate drive voltage control mechanism.

18-19. (canceled)

20. The wireless power reception system of claim 17, wherein the configurations of the first switch network and the second switch network are dynamically adjusted to change at least one of the first impedance and the second impedance in accordance with measurements of an output voltage of the rectifier.
